(19) United States
(12) Patent Application Publication
(10) Pub. No.: US 2022/0282546 A1
(43) Pub. Date: Sep. 8, 2022

(54) ACTUATOR FOR A SIDE DOOR OF A MOTOR VEHICLE

(71) Applicant: Vitesco Technologies GmbH, Regensburg (DE)

(72) Inventor: Karl Martin Fritsch, Frankfurt (DE)

(73) Assignee: Vitesco Technologies GmbH, Regensburg (DE)

(21) Appl. No.: 17/752,690

(22) Filed: May 24, 2022

Related U.S. Application Data
(63) Continuation of application No. PCT/EP2020/077842, filed on Oct. 5, 2020.

(30) Foreign Application Priority Data
Nov. 25, 2019 (DE) 102019218169.4

(51) Int. Cl. E05F 15/63

(52) U.S. Cl. CPC E05F 15/63; E05Y 2201/434; E05Y 2400/302; E05Y 2400/31; E05Y 2400/40; E05Y 2900/531; E05Y 2201/418; E05Y 2400/44

(57) ABSTRACT

An actuator for a side door of a motor vehicle is described. The actuator brings about automatic opening or closing of the side door depending on a signal. The actuator has an electric motor which, depending on an activation, generates a torque which acts on a hinge of the side door via a transmission. Furthermore, it has a device for holding the side door in any open position, which holding device is realized by a function of the electric motor itself which is designed in such a way that, in the currentless state, it has an increased cogging torque which is configured to a value required as a holding torque for holding the door open. In this way, the actuator is distinguished by a simple and inexpensive design.

### CROSS-REFERENCE TO RELATED APPLICATIONS

This application claims priority to PCT Application PCT/EP2020/077842, filed Oct. 5, 2020, which claims priority to German Patent Application No. DE 10 2019 218 169.4, filed Nov. 25, 2019. The disclosures of the above applications are incorporated herein by reference.

### FIELD OF THE INVENTION

The present invention relates to an actuator for a side door of a motor vehicle, which brings about automatic opening or closing of the side door depending on a signal, having an electric motor which is activated by the signal via a control device and which, depending on the signal, generates a torque which acts on a hinge of the side door via a transmission, and a device for holding the side door in any open position.

### BACKGROUND OF THE INVENTION

Motor vehicle doors that are not provided with an actuator are opened or closed by actuation of the door handle and exertion of pressure against the door. In the open position, in addition to an end position, the door assumes certain holding (latching) positions in which the door movement is stopped and a corresponding resistance has to be overcome for further movement. In order to realize these holding positions, the door opening and closing mechanism is provided with certain additional devices, such as brakes, blocking devices and the like. The arrangement of such devices is correspondingly complicated.

Furthermore, motor vehicle doors are known which are provided with corresponding actuators. Such an actuator for a side door of a motor vehicle is de- scribed in the introduction. It brings about automatic opening and closing of the side door upon activation of a signal by actuation of the door handle, of a push button on the dashboard or by activation via radio, etc. In the process, the signal activates an electric motor of an actuator via a control device, which electric motor, depending on the signal, generates a torque acting on a hinge of the side door via a transmission. The door is opened or closed in this way, this being able to be carried out in any position, for example an end position or any intermediate position. A suitable sensor device here can specify the door position to be achieved, for example.

Even in the case of doors of this type that are provided with an actuator, it is known to generate certain holding points for holding the door open, for which purpose, for example, additional braking devices, etc., are provided, which can be provided in addition to the actuator or within the actuator.

### SUMMARY OF THE INVENTION

The present invention is based on the object of creating an actuator of the type described in the introduction, which is distinguished by a simple and inexpensive design.

This object is achieved according to the invention in the case of an actuator of the type specified in that the holding device is realized by a function of the electric motor itself which is designed in such a way that, in the currentless state, it has an increased cogging torque which is configured to a value required as a holding torque for holding the door open.

It is known that electric motors have what is referred to as a parasitic torque, also referred to as a cogging torque. If the motor becomes currentless and comes to a standstill in a certain position, such a torque or cogging torque first has to be overcome in order to restart the motor. The present invention exploits this fact by specifically providing the electric motor of the actuator with an increased cogging torque that is of a magnitude such that a holding torque that is necessary or sufficient to hold the door open without moving is produced in any position of the motor that corresponds to a corresponding open position of the vehicle door. In other words, in order to move the door further (both in the opening and in the closing direction), a counterforce generated by the cogging torque or holding torque first has to be overcome. Certain holding positions of the door is therefore achieved and maintained without special additional devices, such as braking devices, blocking devices and the like, having to be provided in the actuator or in addition to the actuator.

The actuator configured according to the invention therefore has no additional device securing a holding position of the door; instead, the electric motor itself secures the holding position by the correspondingly increased cogging torque having to be overcome upon restarting of the motor. The door therefore cannot readily move further and, as in the prior art described in the introduction, takes up a latching position.

The actuator configured according to the invention is fastened to the vehicle body in the region of the door hinge and outputs the torque of its electric motor via a suitable transmission to the door hinge in order to rotate same. Here, for example, a bolt in the door hinge is rotated such that the door is opened or closed. The door is opened here up to a maximum angle of 70° , for example.

In other words, in the case of the present invention, the electric motor of the door actuator is designed in such a way that, when the motor is stopped, an increased cogging torque is produced, which causes the door to remain in the corre- sponding holding position.

The electric motor of the actuator is embodied as a brushless direct current motor.

In order to realize the increased cogging torque of the electric motor, in one embodiment of the latter, the air gap of the electric motor is small. In another solution, the electric motor has few grooves and poles. These structural measures make it possible to increase the cogging torque of the motor in such a way that it is used as a holding torque for holding the door open.

The actuator designed according to the invention may also have a sensor device which specifies specific holding positions of the side door. If, for example, an object is present that obstructs or prevents further opening of the door, the sensor sends a suitable signal to a control device that controls the electric motor into a specific holding position in which the door is held open owing to the increased cogging torque.

It goes without saying that the cogging torque of the electric motor is converted via the associated transmission into a holding torque of the door in a desired position. In other words, the maximum torque in the currentless state of the electric motor is converted via the transmission into the corresponding holding torque for the door. The transmission is therefore configured in such a way that the corresponding cogging torque of the electric motor is intensified and results in an intensified holding torque.

### BRIEF DESCRIPTION OF THE DRAWINGS

The invention will be explained in detail below with reference to an exemplary embodiment in conjunction with the drawing, in which:

FIG. 1 shows an exemplary embodiment of an actuator which is installed in a motor vehicle;

FIG. 2 shows a highly schematized side view of the actuator;

FIG. 3 shows a highly schematized top view of the actuator in the closed position of the door;

FIG. 4 shows a highly schematized top view of the actuator when the door is open;

FIG. 5 shows a highly schematized section through an electric motor of the actuator; and

FIG. 6 shows a diagram showing the cogging torque depending on the angle of rotation.

### DETAILED DESCRIPTION OF THE PREFERRED EMBODIMENT

The following description of the preferred embodiment(s) is merely exemplary in nature and is in no way intended to limit the invention, its application, or uses.

The exemplary embodiment described here involves an actuator for a side door of a motor vehicle, which, depending on a signal, causes the side door to open or close automatically. The actuator has an electric motor which is activated by the signal via a control device and which, depending on the signal, generates a torque which acts on a hinge of the side door via a transmission.

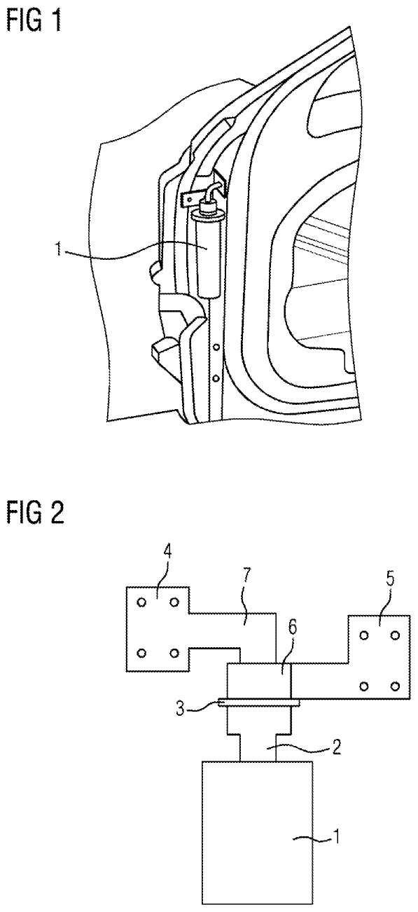

FIG. 1 shows the actuator 1 installed on the A-pillar of a motor vehicle.

FIG. 2 shows the actuator 1 in a highly schematized side view. The actuator 1 has an electric motor (not specifically shown) which has a drive shaft 2 which extends upward in the figure and exerts a corresponding torque. The shaft 2 actuates a rotary arm 6 which is mounted on a sliding element 3 and is fastened in a vehicle door. The corresponding mechanism is held via an arm 7 fastened to the Apillar of a motor vehicle, as shown at 4.

Rotation of the motor shaft 2 therefore causes the rotary arm 6 to pivot and thus opens or closes the vehicle door.

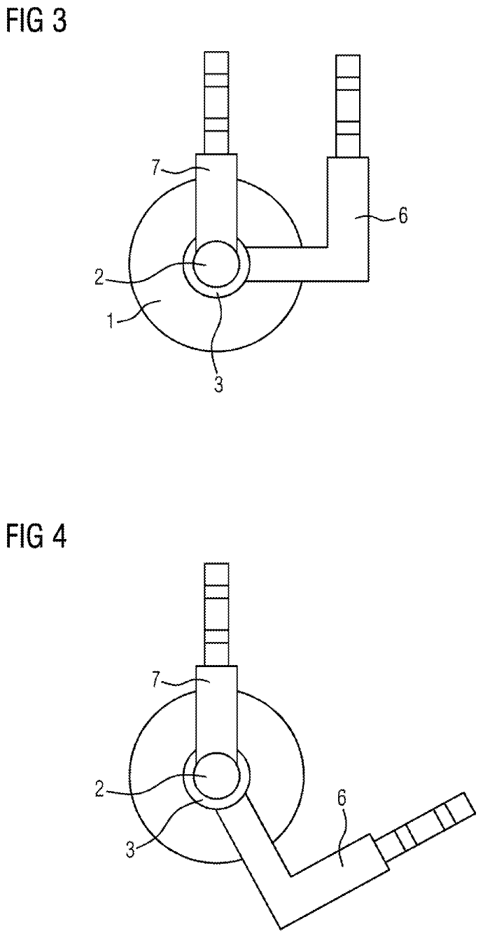

FIGS. 3 and 4 each show a schematized top view of the actuator 1 with a corresponding actuating mechanism (transmission) for the vehicle door, with FIG. 3 showing the arm 6 with the door closed and FIG. 4 showing the arm 6 with the door open.

The actuator 1 illustrated and described here furthermore has a device for holding the vehicle side door in any open position, which holding device is realized by a function of the electric motor itself. In this case, the electric motor is designed in such a way that, in the currentless state, it has an increased cogging torque which is configured to a value required as a holding torque for holding the vehicle door open. Here, the cogging torque of the motor is intensified further to the holding torque via the transmission mechanism provided.

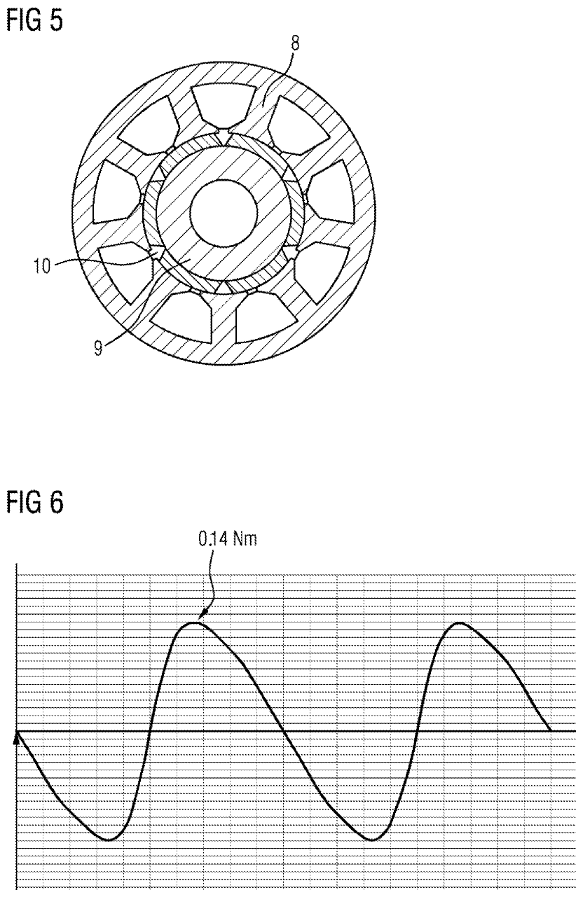

FIG. 5 shows a schematized partial section through an electric motor of the actuator 1. The motor has a rotor 9 and a stator 8 which are separated from one another by an air gap 10. By a correspondingly small configuration of the air gap 10, a cogging torque of the electric motor is generated, which, optionally by being intensified via the associated transmission, becomes a holding torque of the vehicle door, which is sufficient to hold the door open in a specific latching position. The diagram in FIG. 6 shows the cogging torque of the motor depending on the angle of rotation, with a maximum cogging torque of 0.14 Nm being generated here as the holding torque.

In the present exemplary embodiment, the maximum cogging torque of 0.14 Nm is multiplied by the transmission ratio of the associated transmission of 375, resulting in a door holding torque of 52 Nm. The torque required to open the door or to move the door further from a holding position is 62 Nm. The holding torque of 52 Nm generated by the cogging torque and intensified by the transmission is therefore sufficient to hold the door open.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An actuator for a side door of a motor vehicle, which brings about automatic opening or closing of the side door depending on a signal, comprising:
a transmission;
an electric motor which is activated by a signal via a control device and which, depending on the signal, generates a torque which acts on a hinge of the side door via the transmission; and
a holding device for holding the side door in any open position, the holding device further comprising:
a function of the electric motor;
wherein during a currentless state of the electric motor, the electric motor has an increased cogging torque which is configured to a value required as a holding torque for holding the door open.

2. The actuator of claim 1, the electric motor further comprising a brushless direct current motor.

3. The actuator of claim 1, wherein the air gap of the electric motor is small.

4. The actuator of claim 1, the electric motor further comprising particularly few grooves and poles.

5. The actuator of claim 1, further comprising a sensor device which specifies specific holding positions of the side door.

6. The actuator of claim 1, wherein the cogging torque of the electric motor is converted via the associated transmission into a holding torque of the door in a desired position.
